(19) United States
(12) Patent Application Publication
(10) Pub. No.: US 2014/0154032 A1
(43) Pub. Date: Jun. 5, 2014

(54) SHEET PROCESSING APPARATUS, METHOD FOR CONTROLLING SHEET PROCESSING APPARATUS, AND STORAGE MEDIUM

(71) Applicant: CANON KABUSHIKI KAISHA, Tokyo (JP)

(72) Inventor: Yoshitake Mizuno, Fujisawa-shi (JP)

(73) Assignee: CANON KABUSHIKI KAISHA, Tokyo (JP)

(21) Appl. No.: 14/090,946

(22) Filed: Nov. 26, 2013

(30) Foreign Application Priority Data
Nov. 30, 2012 (JP) 2012-262450

(51) Int. Cl. B42B 5/00

(52) U.S. Cl. CPC B42B 5/00
USPC 412/6; 412/33; 412/13

(57) ABSTRACT

There is provided a sheet processing apparatus capable of accurately recognizing where sheets are separated based on a concave and convex mark on a sheet without use of a specific partition sheet by utilizing a binding method for performing a binding process on sheets without use of a staple. A control method for controlling a sheet processing apparatus includes performing a binding process for binding a plurality of sheets without use of a staple by a binding unit, setting a sheet on which a concave and convex mark is to be formed by the binding unit, and controlling the binding unit so as to form the concave and convex mark on the set sheet.

### BACKGROUND OF THE INVENTION

1. Field of the Invention

The present invention relates to a sheet processing apparatus, a method for controlling a sheet processing apparatus, and a storage medium.

2. Description of the Related Art

Image forming apparatuses having a copy function and a printer function are provided with a function of inserting a sheet from a cassette tray different from a document main body. More specifically, there are a function of inserting a cover, a chapter sheet, and a slip sheet in a document main body, and a function of inserting a partition sheet, i.e., inserting a sheet from a different sheet feed unit between jobs and copies.

Further, for example, there are a function of printing a job while interrupting another job during outputting thereof, like interrupt copy, and a function of outputting a plurality of sheets with a patch pattern printed thereon and scanning the last sheet by a scanner to thereby improve correction accuracy for the purpose of stabilizing tint at the time of automatic gradation correction.

The above-described sheet insertion functions involve such a problem that a position of an inserted sheet cannot be specified unless a sheet of a different color or a different type is used as the inserted sheet. Further, when using the interrupt copy function, a user cannot easily determine from which sheet the user's output starts unless the user checks the printed contents, since the output sheets are inserted among a plurality of outputs.

Further, automatic gradation correction also requires a user to check printed contents to specify the last output among outputs to determine the last sheet allowed to be used in the automatic gradation correction.

As a measure for solving these problems, Japanese Patent Application Laid-Open No. 5-297693 discusses a technique of printing a mark so as to black an edge of a sheet, a date, a time, and a username to allow easy discrimination of the sheet.

Further, to provide another solution to these problems, Japanese Patent Application Laid-Open No. 2007-118374 discusses a technique of improving visibility by using a colored sheet.

On the other hand, some image forming apparatuses are equipped with a sheet processing apparatus configured to perform post processing on an output printed sheet. One representative function of this sheet processing apparatus is a stapling/binding function. The stapling/binding function is a function of binding sheets using a metallic wire. The stapled and bound print products can be easily handled as a single copy set, and therefore this function is widely used when treating an output constituted by a plurality of pages.

Further, in recent years, consideration has been given to an environment since the stapling/binding function uses a metallic staple, and there has been proposed a binding method that does not use a staple. For example, Japanese Patent Application Laid-Open No. 8-300847 discusses a method for collectively cutting out a part of a set of printed sheets to be bound as if gouging out it, and folding the cut tips in, thereby binding the sheets.

Other than that, various binding methods that do not use a metallic staple have been put into practical use. Examples thereof include a method for binding sheets by joining the sheets with glue, and a method for binding sheets by applying a pressure vertically in a thickness direction of the sheets to press the sheets into close contact with one another with the aid of the applied pressure.

Herein, the term “three-dimensional mark” will be used to refer to a function of partially changing the thickness of a sheet, and changing a texture of a sheet, like this stapling/binding method.

If a mark, a date, a time, and a username are printed at an edge of a sheet, like conventional techniques, a user cannot recognize the position thereof unless the user visually checks the printed surfaces by flipping through the outputs, whereby it is difficult to discriminate the insertion point among a large amount of outputs. Further, even with use of a colored sheet, a user should carefully search for the insertion point. Further, toner should be additionally consumed, leading to an increase in the cost.

Further, the sheet insertion function additionally inserts another sheet different from the document main body, and therefore outputs an extra sheet, leading to an increase in the cost.

### SUMMARY OF THE INVENTION

According to an aspect of the present invention, a sheet processing apparatus includes a binding unit configured to perform a binding process for binding a plurality of sheets without use of a staple, a setting unit configured to set a sheet on which a concave and convex mark is to be formed by the binding unit, and a control unit configured to control the binding unit so as to form the concave and convex mark on the sheet set by the setting unit.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image processing apparatus to which a sheet processing apparatus can be applied.

FIG. 2 illustrates a configuration of a sheet processing unit.

FIG. 3 illustrates stapling operations of staple units.

FIGS. 4A and 4B are cross-sectional views illustrating binding process by a staple unit illustrated in FIG. 2.

FIG. 5 is a cross-sectional view illustrating the binding process by the staple unit illustrated in FIG. 2.

FIG. 6 is a top view illustrating the binding process by the staple unit illustrated in FIG. 2.

FIGS. 7A and 7B are top views illustrating the binding process by the staple unit illustrated in FIG. 2.

FIG. 8 is a top view illustrating the binding process by the staple unit illustrated in FIG. 2.

FIG. 9 illustrates an example of a user interface (UI) screen displayed on an operation unit illustrated in FIG. 1.

FIG. 10 illustrates an example of a UI screen displayed on the operation unit illustrated in FIG. 1.

FIG. 11 illustrates an example of a UI screen displayed on the operation unit illustrated in FIG. 1.

FIG. 12 illustrates an example of a UI screen displayed on the operation unit illustrated in FIG. 1.

FIG. 13 illustrates an example of a UI screen displayed on the operation unit illustrated in FIG. 1.

FIG. 14 illustrates an example of a UI screen displayed on the operation unit illustrated in FIG. 1.

FIG. 15 illustrates an example of a UI screen displayed on the operation unit illustrated in FIG. 1.

FIG. 16 illustrates an example of a UI screen displayed on the operation unit illustrated in FIG. 1.

FIG. 17 illustrates an example of a UI screen displayed on the operation unit illustrated in FIG. 1.

FIG. 18 illustrates an example of a UI screen displayed on the operation unit illustrated in FIG. 1.

FIG. 19 illustrates an example of a UI screen displayed on the operation unit illustrated in FIG. 1.

FIG. 20 illustrates an example of a UI screen displayed on the operation unit illustrated in FIG. 1.

FIG. 21 illustrates a table illustrating three-dimensional mark formation information about a three-dimensional mark to be formed on a sheet.

FIG. 22 is a flowchart illustrating a method for controlling the sheet processing apparatus according to an exemplary embodiment of the present invention.

FIG. 23 (divided into FIGS. 23A and 23B) is a flowchart illustrating the method for controlling the sheet processing apparatus according to the exemplary embodiment of the present invention.

FIG. 24 is a flowchart illustrating the method for controlling the sheet processing apparatus according to the exemplary embodiment of the present invention.

FIG. 25 is a flowchart illustrating the method for controlling the sheet processing apparatus according to the exemplary embodiment of the present invention.

### DESCRIPTION OF THE EMBODIMENTS

Next, an exemplary embodiment for carrying out the present invention will be described with reference to drawings.

### <System Configuration>

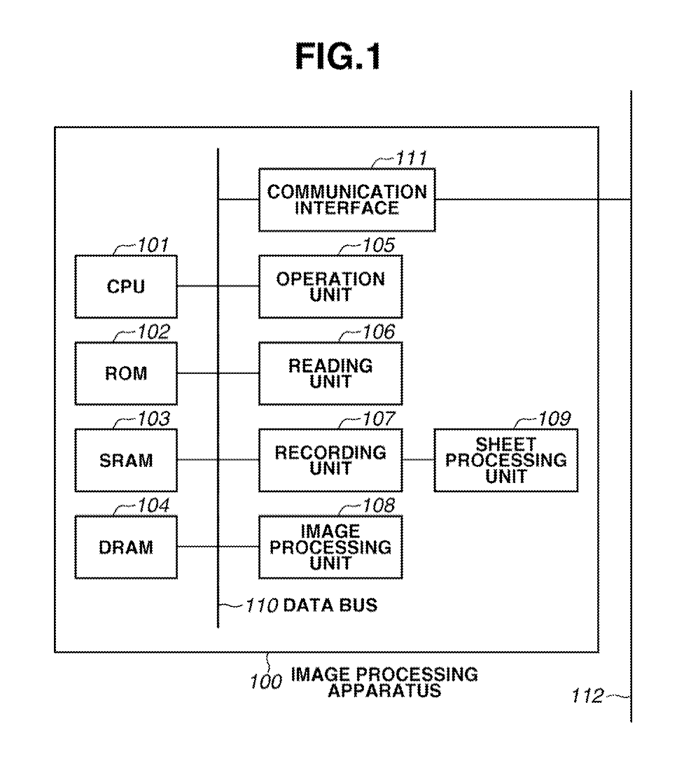

FIG. 1 is a block diagram illustrating a configuration of an image processing apparatus to which a sheet processing apparatus according to the present exemplary embodiment can be applied. The present exemplary embodiment is described based on an example in which the image processing apparatus is a multifunction peripheral (MFP) that can be also used as a copying machine.

In FIG. 1, a central processing unit (CPU) 101 controls the entire apparatus as a control unit of a system. A read only memory (ROM) 102 is used to store a control program of the CPU 101. A static random access memory (SRAM) 103 is used to store setting values registered by an operator, management data of the apparatus, and the like, and a buffer for various kinds of works and the like. The SRAM 103 is a non-volatile SRAM that is backed up by a battery, and holds a stored content even when the image processing apparatus is powered off. Read image data is also stored in the SRAM 103.

A dynamic random access memory (DRAM) 104 is used to store program control variables and the like. An operation unit 105 is an interface unit to a user, which displays information in the apparatus. A reading unit 106 is a device that reads image data and converts it into binary data. The image processing apparatus reads a document for an image transmission function by using the reading unit 106. A recording unit 107 is a device that outputs image data onto a recording sheet. An image processing unit 108 codes and decodes image data processed by the image transmission function. The respective control units are connected via a data bus 110, and image data is transferred via the data bus 110.

Further, the recording unit 107 is connected to a sheet processing unit 109, and an output sheet printed by the recording unit 107 is conveyed to the sheet processing unit 109. The sheet processing unit 109 is a unit that performs post processing such as alignment of output sheets input from the recording unit 107, switching output trays, and stapling and binding the sheets. The sheet processing unit 109 includes two staple units, i.e., a binding unit (a staple unit) that binds sheets without use of a staple, and a binding unit (a staple unit) that binds sheets with use of a staple.

By way of example, the present exemplary embodiment is described based on such a multifunction peripheral that reads a document image and converts it into binary data by the reading unit 106, temporarily stores the read image data into the SRAM 103, converts the stored image data by the image processing unit 108, prints the image data on a sheet by the recording unit 107, and performs sheet post processing thereon by the sheet processing unit 109.

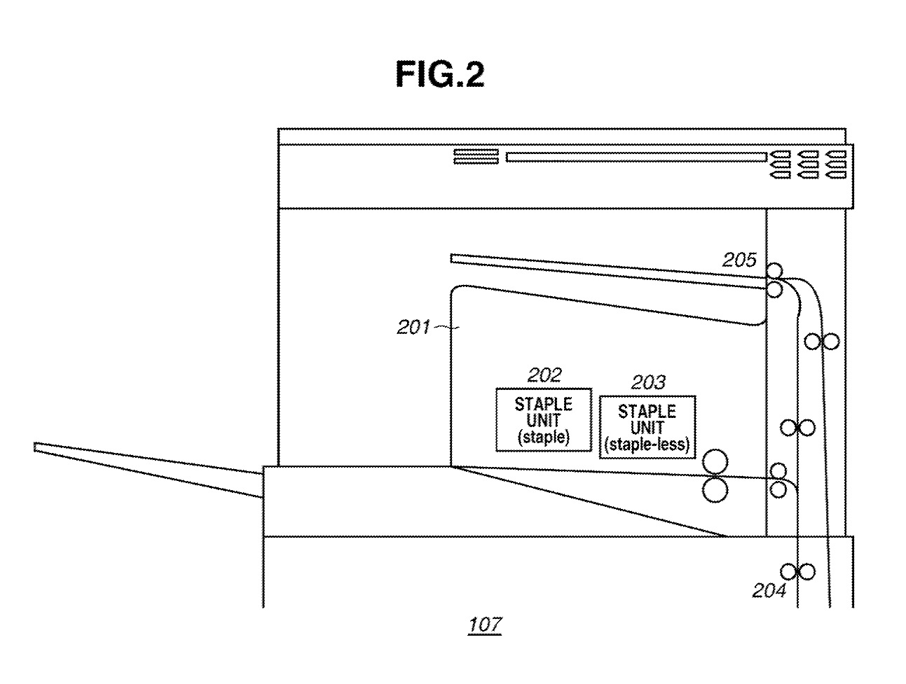

FIG. 2 illustrates a configuration of the sheet processing unit 109 illustrated in FIG. 1. In the present exemplary embodiment, for example, a sheet processing apparatus is mounted within a housing of the multifunction peripheral.

In FIG. 2, a sheet processing unit 201 is connected to the recording unit 107. A sheet is transferred from the recording unit 107 via conveyance rollers 204. Conveyance rollers 205 rotate a sheet in a reverse direction at the time of two-sided printing. The sheet is transmitted therethrough when being rotated in the reverse direction, and is introduced into the recording unit 107 again to allow data to be printed on the back surface thereof. In this case, the output sheet is also transferred to the sheet processing unit 201 via the conveyance rollers 204.

The sheet processing unit 201 has a function of aligning or moving output sheets, but the present exemplary embodiment is described focusing on the stapling/binding function. A staple unit 202 staples sheets with use of a staple. The staple unit 202 provides a function of binding sheets with use of a metallic wire such as a staple.

A staple unit 203 binds sheets without use of a staple (staple-less). The staple unit 203 provides a function of stapling and binding sheets without use of a staple. There are various methods for stapling and binding sheets without use of a staple as described above, and the present exemplary embodiment is described based on an example in which the sheet processing unit 201 is equipped with the staple unit 203 employing a method for binding sheets by applying a pressure vertically in a thickness direction of the sheets to press the sheets into close contact with one another with the aid of the applied pressure.

In this manner, in the present exemplary embodiment, the sheet processing unit 201 includes a sheet processing unit including both the staple unit 202 that uses a staple and the staple unit 203 that does not use a staple by way of example. However, the sheet processing unit 201 may be configured to include only the staple unit 203 that does not use a staple.

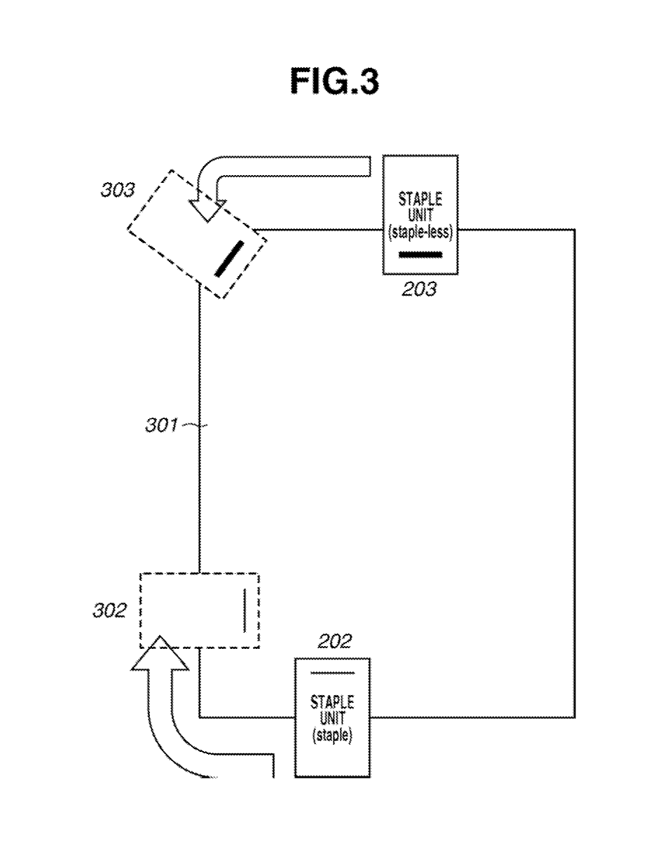

FIG. 3 illustrates stapling operations of the staple units 202 and 203 illustrated in FIG. 2. The example illustrated in FIG. 3 shows positional relationships between sheets, and the staple units 202 and 203 which staple and bind the sheets.

FIG. 3 illustrates output sheets 301 to be bound. The staple unit 202 is configured to move from a standby position of the stapling/binding unit that uses a staple to a stapling position 302, and bind the output sheets 301 at the position, when actually binding the output sheets 301.

The staple unit 203 is configured to move from a standby position of the stapling/binding unit that does not use a staple to a stapling position 303, and bind the output sheets 301 at the position, when actually binding the output sheets 301. In other words, the staple units 202 and 203 is configured to be movable to a binding position to staple sheets at the position under control of the CPU 101 illustrated in FIG. 1, according to various binding methods.

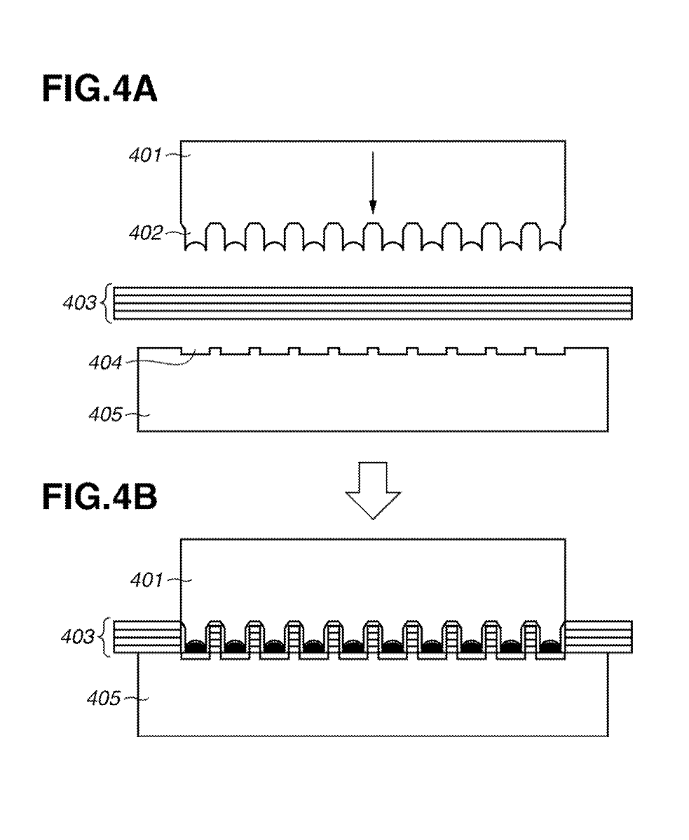

FIGS. 4A and 4B are cross-sectional views illustrating a binding process by the staple unit 203 illustrated in FIG. 2. The present exemplary embodiment is described based on a method for binding sheets by applying a pressure vertically in a thickness direction of the sheets to press the sheets into close contact with one another with the aid of the applied pressure. More specifically, FIG. 4A corresponds to such a state that output sheets are set at the binding position, and the staple unit 203 moves to the stapling position 303 where the staple unit 203 binds the output sheets as illustrated in FIG. 3.

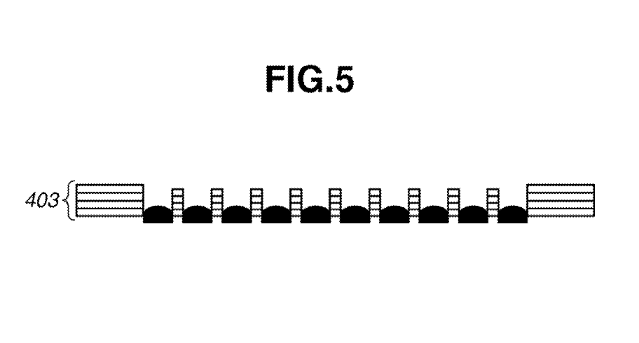

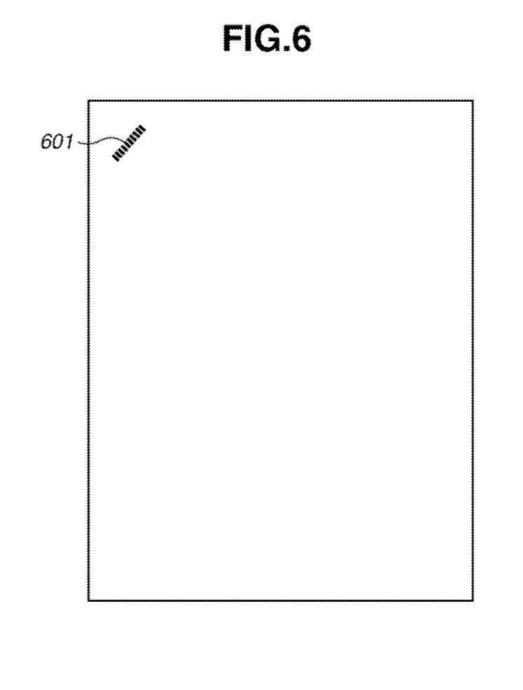

In FIGS. 4A and 4B, an upper die 401 presses and holds the sheets by a pressure. The upper die 401 includes a plurality of convex blades, and binds the sheets in such a manner that they cannot be easily detached from one another by pressurizing them at a plurality of positions. A lower die 405 presses and holds the sheets by a pressure. The lower die 405 also includes concave portions 404 corresponding to the plurality of convex portions 402 of the upper die 401, and is configured to receive the blades of the upper die 401. The staple unit 203 is configured to be able to pressurize an output sheet bundle 403 vertically by the upper die 401 and the lower die 405 as illustrated in FIG. 4B (using a not-illustrated pressurization mechanism) to hold it, thereby binding the sheets. FIG. 5 illustrates a cross-section of the bound output sheet bundle 403. As illustrated in FIG. 6, a stapled bound portion 601 can be visually confirmed by viewing the bound output sheet bundle 403 from above.

In the present exemplary embodiment, black portions of the bound portion 601 illustrated in FIG. 6 correspond to pressurized and crashed portions of the sheets. The number of sheets that this method can bind is limited currently, because this method binds the sheets by pressurizing them.

Further, the binding force is weak by only a single binding operation, whereby the staple unit 203 is configured to be able to bind sheets twice or the like, as will be described below.

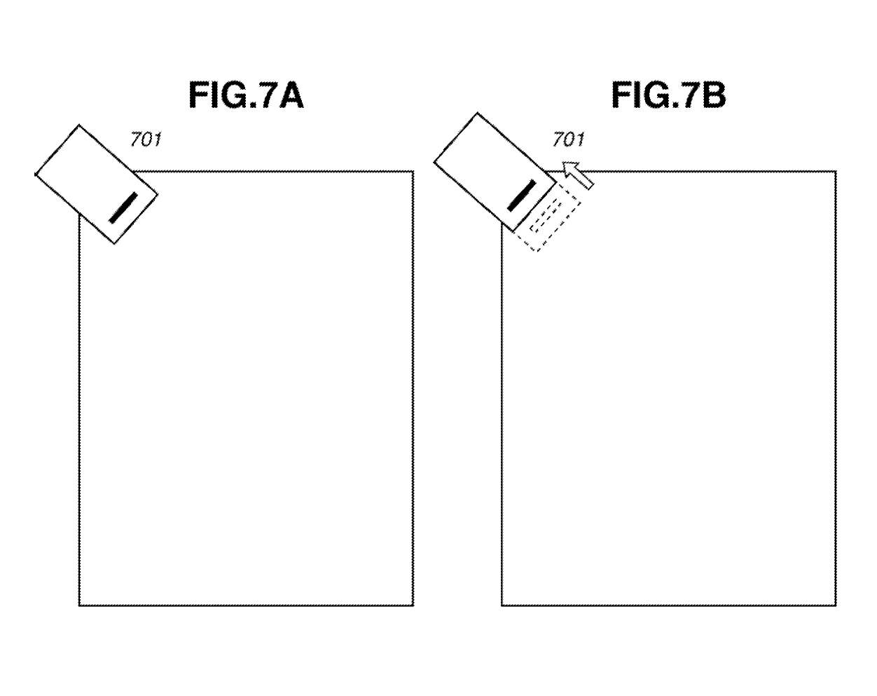

A binding unit 701 is configured to be movable from a position illustrated in FIG. 7A to a position illustrated in FIG. 7B. Further, the binding unit 701 is configured to change a binding position and the number of times of binding by adjusting a movement amount.

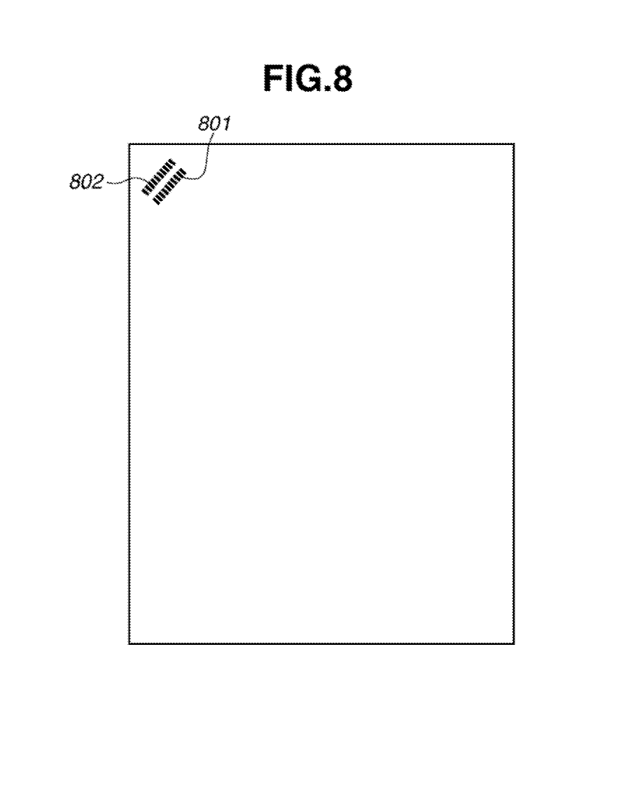

FIG. 8 illustrates output sheets bound twice by the binding unit 701 as viewed from above. FIG. 8 illustrates a bound portion 801, which is formed by the binding operation illustrated in FIG. 7A, and a bound portion 802, which is formed by a further binding operation. According to an increase in the number of pressurized blacked portions illustrated in FIG. 8, a pressure bonding force increases and a binding force increases.

Further, the stapling/binding method that does not use a staple is characterized in that sheets can be detached beautifully without being torn by rubbing the pressurized bound portion with a nail or the like.

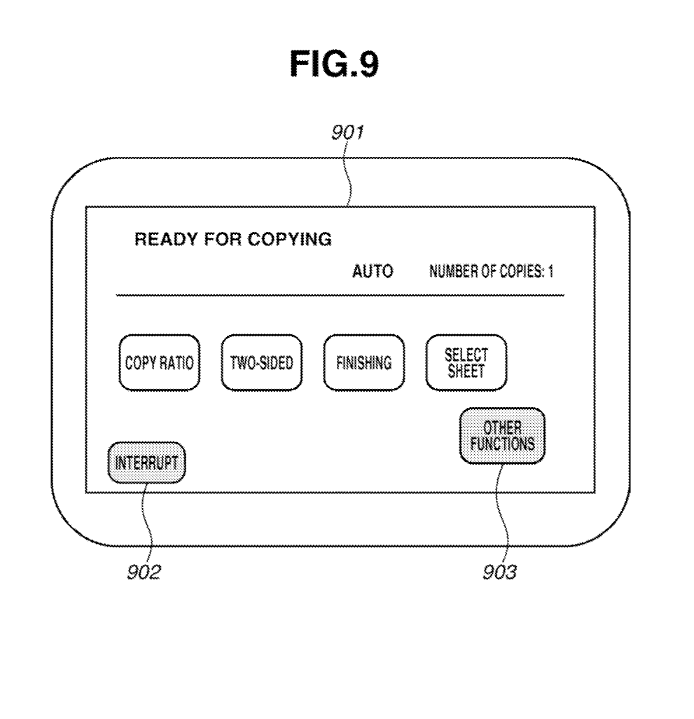

FIGS. 9 to 20 each illustrate an example of a UI screen displayed on the operation unit 105 illustrated in FIG. 1. In the following description, an example of an operation when a stapling processing is performed will be described with reference to the respective UI screens. The CPU 101 displays a UI screen on the operation unit 105 according to a program stored in the ROM 102, thereby realizing the display on the operation unit 105. The present exemplary embodiment includes the screens illustrated in FIGS. 9 to 20, which will be described below, as screens for setting formation conditions under which the concave and convex mark is formed on a sheet as a divider. Then, subject to the mark formation conditions set with use of these UI screens, the CPU 101 controls the sheet processing unit 109 to perform the binding process so as to form the concave and convex mark on the fed sheet according to procedures illustrated in flowcharts, which will be described below.

FIG. 9 illustrates an example of a UI screen that allows a user to set a copy operation.

Referring to FIG. 9, a copy basic screen 901 includes an interrupt copy button 902, which allows the user to put a new copy job ahead of an already set job, and an other-functions button 903, which allows the user to display functions that cannot be accommodated in the copy basic screen 901.

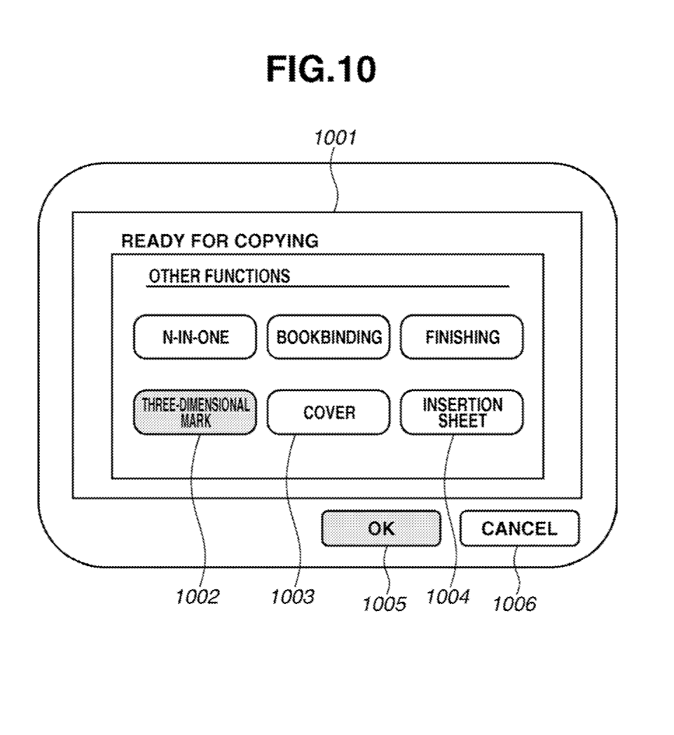

FIG. 10 illustrates an example of a UI screen associated with the other functions, which is displayed when the other-functions button 903 is pressed by the user.

Referring to FIG. 10, an other-functions screen 1001 includes a three-dimensional mark function button 1002, a cover function button 1003, and an insertion sheet function button 1004. When an OK button 1005 is pressed by the user, the screen returns to the copy basic screen 901 with setting information selected so far being stored. When a cancel button 1006 is pressed, the screen returns to the copy basic screen 901 while setting information selected so far is discarded.

The cover function is a function that allows the user to specify a sheet feed tray different from a document main body as a cover. Further, the insertion sheet function is a function that allows the user to specify a sheet feed tray different from a document main body as a slip sheet or a chapter sheet, and insert the slip or chapter sheet at an arbitrary position.

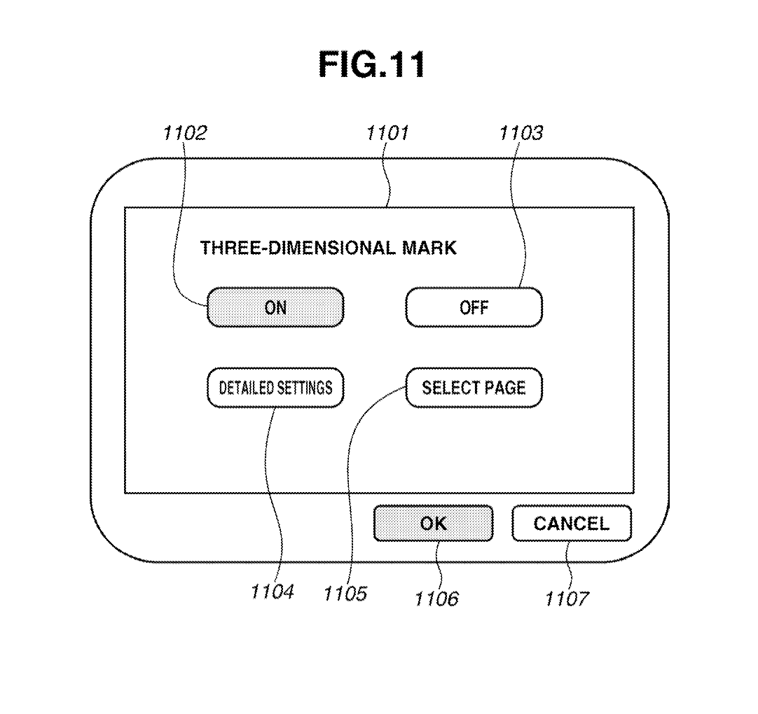

FIG. 11 illustrates an example of a UI screen associated with settings of the three-dimensional mark, which is displayed when the three-dimensional mark function button 1002 is pressed by the user.

Referring to FIG. 11, a three-dimensional mark setting screen 1101 includes a button 1102 for selecting formation of the three-dimensional mark, a button 1103 for deselecting formation of the three-dimensional mark, a detail setting button 1104, and a page selection button 1105. When an OK button 1106 is pressed by the user, the screen returns to the other-functions screen 1001 with setting information selected so far being stored. When a cancel button 1107 is pressed, the screen returns to the other-functions screen 1001 while setting information selected so far is discarded.

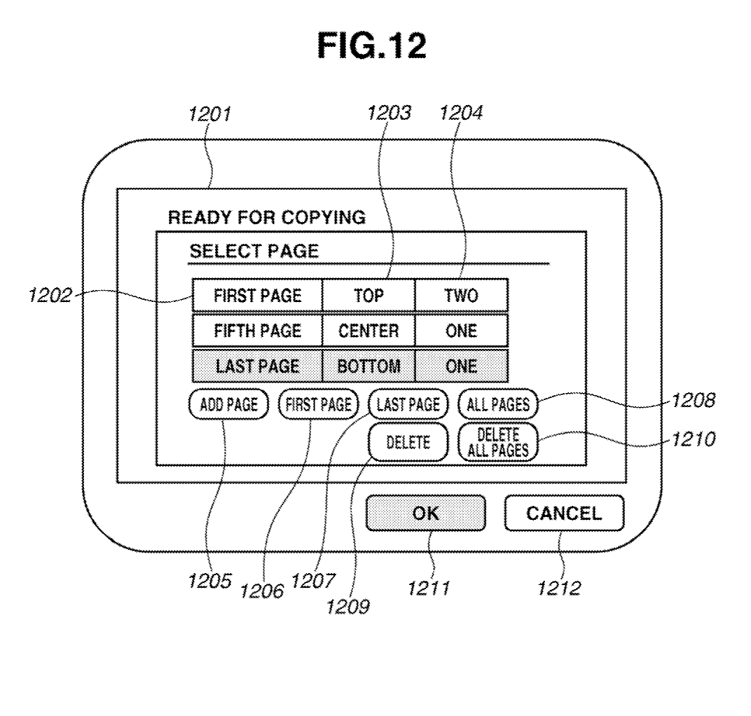

FIG. 12 is an example of a UI screen associated with an operation of a page selection in the settings of the three-dimensional mark, which is displayed when the page selection button 1105 is pressed by the user.

Referring to FIG. 12, a page selection screen 1201 includes a list constituted by fields 1202 each indicating a page on which the mark is planned to be formed currently, fields 1203 each indicating a position where the mark will be formed, and fields 1204 each indicating the number of marks. Further, the page selection screen 1201 includes a page insertion button 1205 for inserting a page, a first page specifying button 1206 for specifying a first page, a last page specifying button 1207 for specifying a last page, an all-pages specifying button 1208 for specifying all pages, a deletion button 1209 for deleting a page, and an all-pages deletion button 1210 for deleting all pages. When the deletion button 1209 is pressed by the user for the setting selected in the list, the selected setting is deleted from the list. When the all-pages deletion button 1210 is pressed by the user, all settings are deleted from the list. When an OK button 1211 is pressed by the user, the screen returns to the three-dimensional mark setting screen 1101 while setting information selected so far is stored. When a cancel button 1112 is pressed, the screen returns to the three-dimensional mark setting screen 1101 while setting information selected so far is discarded.

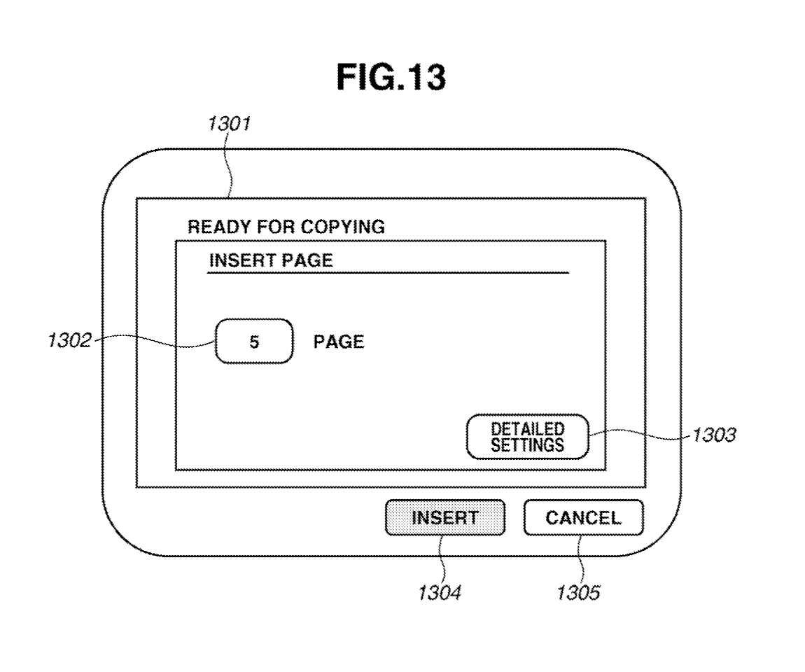

FIG. 13 illustrates an example of a UI screen associated with an operation of specifying a page number in the settings of the three-dimensional mark, which is displayed when the page insertion button 1205 is pressed by the user.

Referring to FIG. 13, a page addition screen 1301 includes a page number specifying box 1302 for specifying a page number, and a detail setting button 1303 for selecting the detailed settings.

When the user specifies a page number in the page number specifying box 1302 and presses an insertion button 1304, the setting of the specified page is added to the list of the page selection screen 1201. When a cancel button 1305 is pressed, the screen returns to the page selection screen 1201.

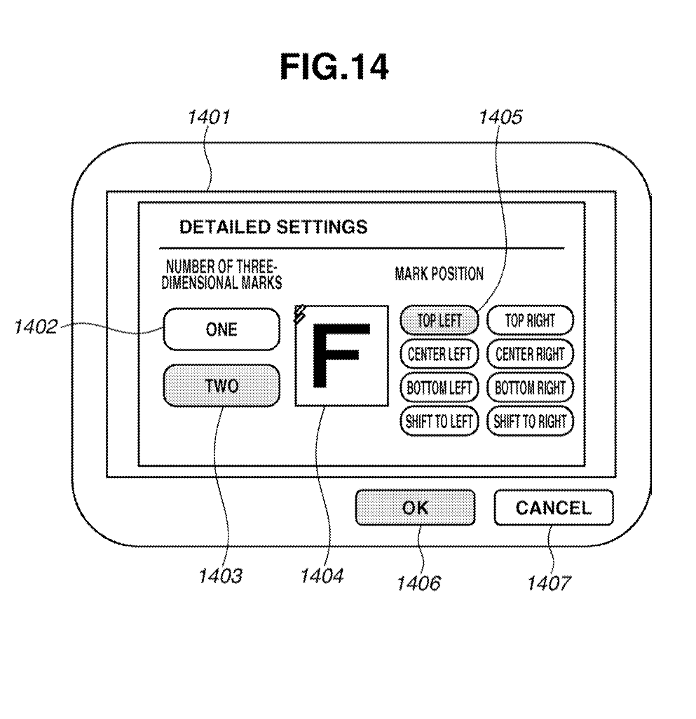

FIG. 14 illustrates an example of a UI screen associated with an operation for selecting the detailed settings in the settings of the three-dimensional mark, which is displayed when the detail setting button 1303 is pressed by the user.

Referring to FIG. 14, a detail setting screen 1401 includes buttons 1402 and 1403 for specifying the number of three-dimensional marks, mark position specifying buttons 1405 for specifying the mark position, and a mark preview screen 1404 displaying a preview of the mark on the sheet. In the present exemplary embodiment, the control for specifying the number of marks is constituted by radio buttons that allow the user to select either one (the button 1402) or two (the button 1403) as the number of marks. Further, the mark position specifying buttons 1405 are displayed so as to allow the user to specify any one of left, right, top, and bottom positions, or specify shift mark formation, according to which the mark is formed while shifting to a different position for each page.

When an OK button 1406 is pressed by the user, the screen returns to the page addition screen 1301 with setting information selected so far being stored. When a cancel button 1407 is pressed, the screen returns to the page addition screen 1301 while setting information selected so far is discarded.

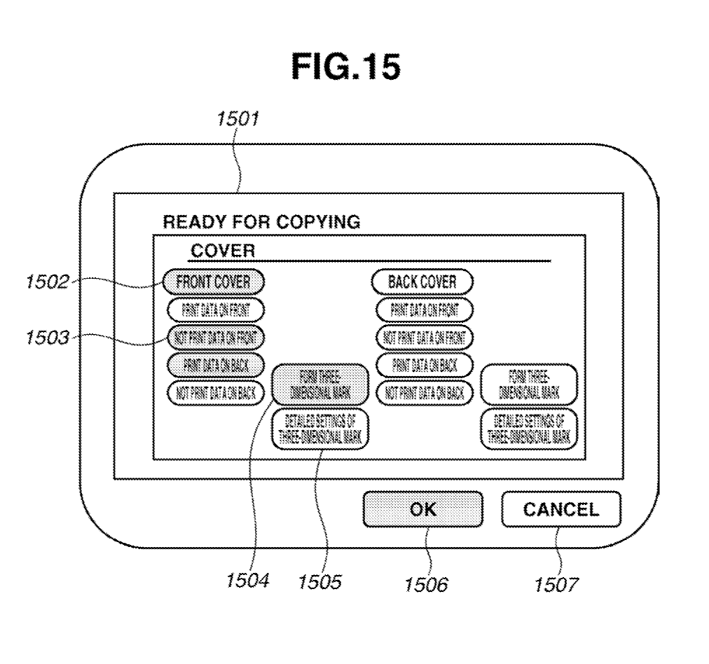

FIG. 15 illustrates an example of a UI screen associated with an operation for setting a cover, which is displayed when the cover function button 1003 is pressed by the user.

Referring to FIG. 15, a cover setting screen 1501 includes buttons 1502 for setting a front cover and a back cover, buttons 1503 for specifying whether to print data on the front cover and the back cover, buttons 1504 for specifying formation of the three-dimensional mark, and buttons 1505 for shifting to the detail setting screen 1401 for selecting the detailed settings of the three-dimensional mark.

When an OK button 1506 is pressed by the user, the screen returns to the other-functions screen 1001 with setting information selected so far being stored. When a cancel button 1507 is pressed, the screen returns to the other-functions screen 1001 while setting information selected so far is discarded.

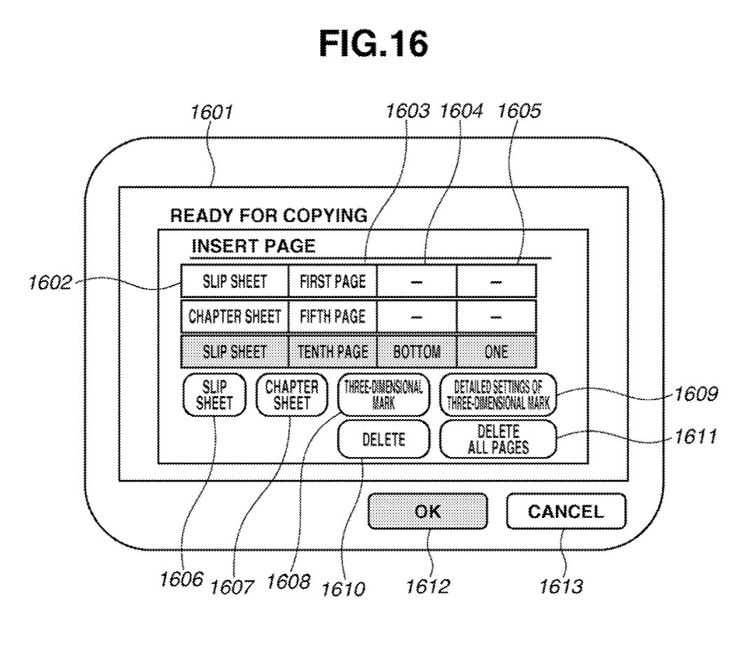

FIG. 16 illustrates an example of a UI screen associated with an operation for setting an insertion sheet, which is displayed when the insertion sheet function button 1004 is pressed by the user.

Referring to FIG. 16, an insertion sheet setting screen 1601 includes a list constituted by fields 1602 each indicating either a slip sheet or a chapter sheet, fields 1603 each indicating a page number where the insertion sheet is inserted, fields 1604 each indicating a position of the three-dimensional mark, and fields 1605 each indicating the number of three-dimensional marks for respective insertion pages. Further, the insertion sheet setting screen 1601 includes a slip sheet insertion button 1606, a chapter sheet insertion button 1607, a three-dimensional mark formation button 1608, a button 1609 for shifting to the screen 1401 for setting the detailed settings of the three-dimensional mark, a deletion button 1610, and an all-pages deletion button 1611. When the user selects a setting of an insertion sheet in the list and presses the three-dimensional mark formation button 1608, a setting of the three-dimensional mark is added to a default mark position with a default number of marks.

When an OK button 1612 is pressed by the user, the screen returns to the other-functions screen 1001 with setting information selected so far being stored. When a cancel button 1613 is pressed, the screen returns to the other-functions screen 1001 while setting information selected so far is discarded.

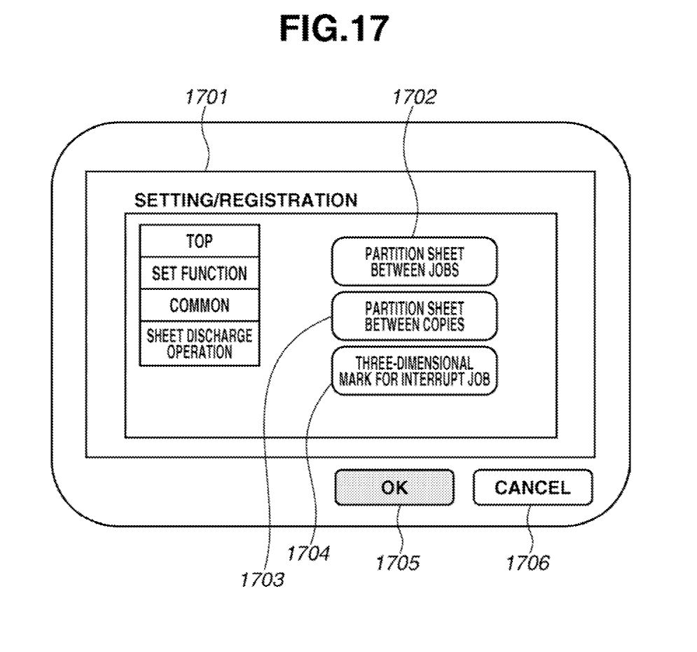

FIG. 17 illustrates an example of a UI screen associated with an operation for setting the apparatus.

Referring to FIG. 17, a setting/registration screen 1701 is displayed when the user registers settings of the apparatus, instead of registering settings for each job. The setting/registration screen 1701 includes a button 1702 for setting a partition sheet between jobs, a button 1703 for setting a partition sheet between copies, and a button 1704 for setting formation of the three-dimensional mark at the time of interrupt copy.

When an OK button 1705 is pressed by the user, the setting/registration screen 1701 is closed with setting information selected so far being stored. When a cancel button 1706 is pressed, the setting/registration screen 1701 is closed while setting information selected so far is discarded.

The partition sheet between jobs means a function of inserting a sheet from a specified sheet feed tray between jobs, thereby allowing easy discrimination of a boundary between the jobs. Further, the partition sheet between copies means a function of inserting a sheet from a specified sheet feed tray every time an arbitrary number of copies are output, thereby allowing easy discrimination of a boundary between a set of the arbitrary number of copies and a next set of the arbitrary number of copies.

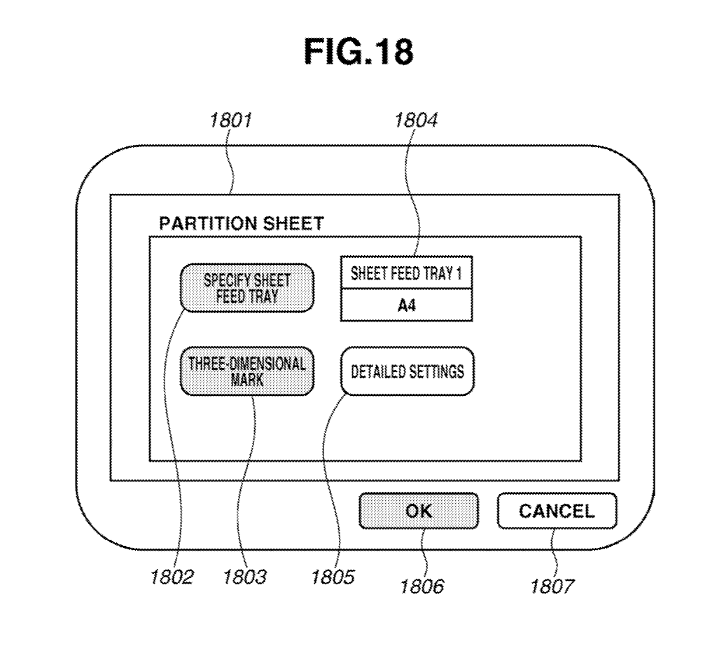

FIG. 18 illustrates an example of a UI screen associated with an operation for setting a partition sheet, which is displayed when the button 1702 or 1703 for setting a partition sheet between jobs or copies is pressed by the user.

Referring to FIG. 18, a partition sheet setting screen 1801 includes a sheet specifying button 1802 for specifying a sheet feed tray, and a sheet feed tray selection button 1804 indicating a sheet feed tray selected by pressing the sheet specifying button 1802 and a set sheet size and type. Further, the partition sheet setting screen 1801 includes a three-dimensional mark formation button 1803 for forming the three-dimensional mark, and a button 1805 for shifting to the screen 1401 for selecting the detailed settings of the three-dimensional mark. Specifying a sheet feed tray and selecting the three-dimensional mark are not exclusive operations, and only inserting a partition sheet or only forming the three-dimensional mark on a first or last sheet of a job or a copy without inserting a sheet are also settable.

When an OK button 1806 is pressed by the user, the screen returns to the setting/registration screen 1701 with setting information selected so far being stored. When a cancel button 1807 is pressed, the screen returns to the setting/registration screen 1701 while setting information selected so far is discarded.

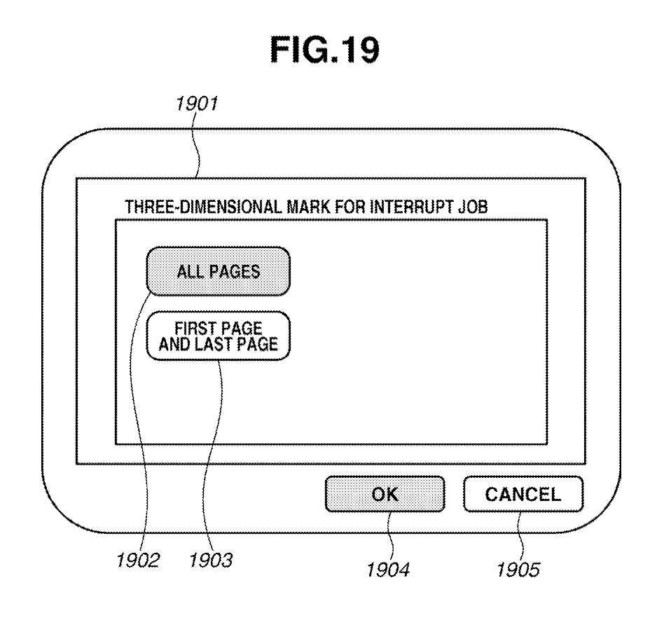

FIG. 19 illustrates an example of an operation unit for setting the three-dimensional mark for interrupt copy, which is displayed when the button 1704 for setting formation of the three-dimensional mark at the time of interrupt copy is pressed by the user.

Referring to FIG. 19, a three-dimensional mark setting screen 1901 for setting the three-dimensional mark at the time of interrupt copy includes a all-pages specifying button 1902 for specifying all pages, and a first page and last page specifying button 1903 for specifying first and last pages.

When an OK button 1904 is pressed by the user, the screen returns to the setting/registration screen 1701 with setting information selected so far being stored. When a cancel button 1905 is pressed, the screen returns to the setting/registration screen 1701 while setting information selected so far is discarded.

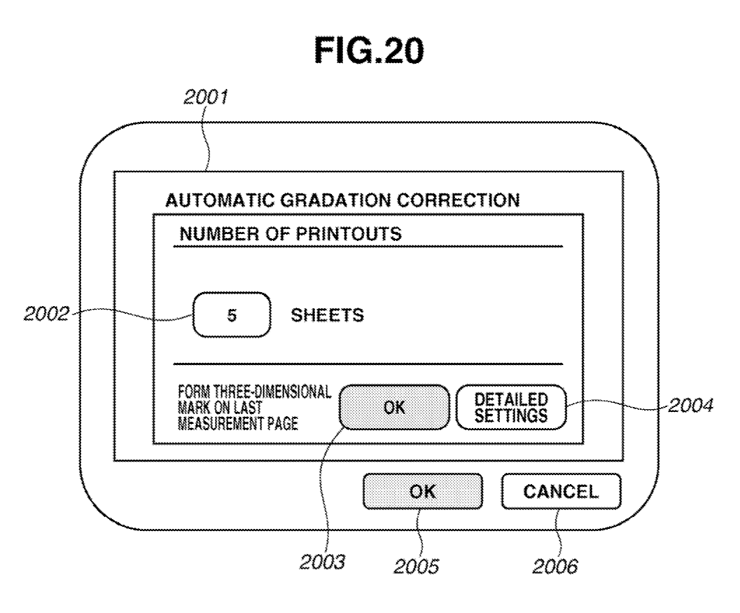

FIG. 20 illustrates an example of a UI screen associated with an operation for specifying the number of printouts for automatic gradation correction.

Referring to FIG. 20, when the user performs automatic gradation correction, an automatic gradation correction setting screen 2001 for automatic gradation correction is displayed to allow the user to register the number of printouts. The automatic gradation correction setting screen 2001 for automatic gradation correction includes a box 2002 for inputting the number of printouts, a button 2003 for forming the three-dimensional mark, and a button 2004 for shifting to the screen 1401 for selecting the detailed settings of the three-dimensional mark. When an OK button 2005 is pressed by the user, the automatic gradation correction setting screen 2001 for automatic gradation correction is closed with setting information selected so far being stored. When a cancel button 2006 is pressed, the automatic gradation correction setting screen 2001 for automatic gradation correction is closed while setting information selected so far is discarded.

Specifying the number of printouts for automatic gradation correction is a function that allows the user to specify the number of printouts, because the accuracy of gradation correction increases by making a correction with use of a last printout among a plurality of continuously printed printouts when outputting an automatic gradation correction pattern but this has a demerit of wastefully using many sheets accordingly.

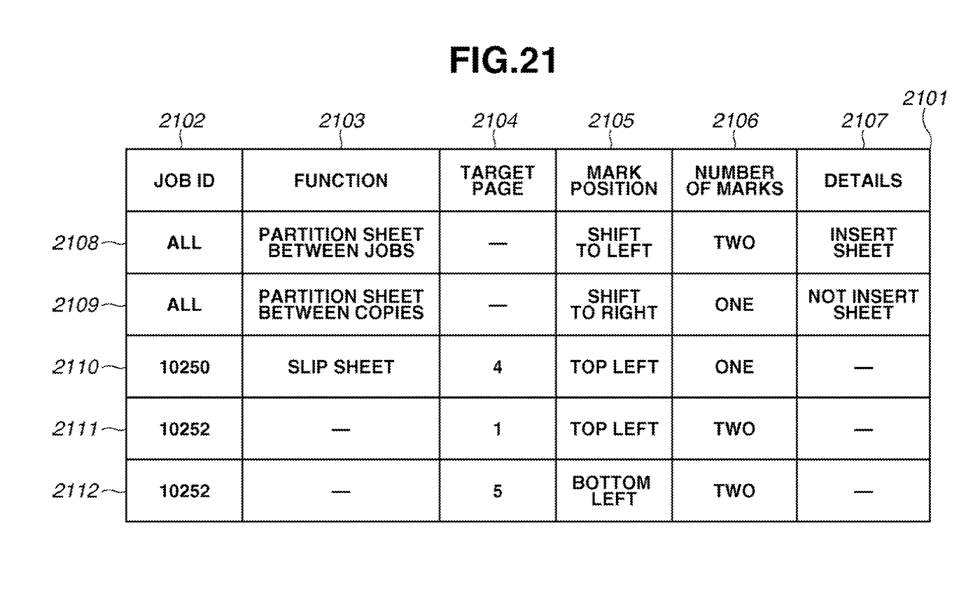

FIG. 21 illustrates an example of three-dimensional mark formation page information associated with the button 2003 for forming the three-dimensional mark illustrated in FIG. 20.

Referring to FIG. 21, a three-dimensional mark formation page information list 2101 is generated by the CPU 101 according to the program stored in the ROM 102, and is stored in the DRAM 104.

The three-dimensional mark formation page information includes a job ID 2102 for identifying a job, a function 2103, a position of a page to be inserted 2104, a mark position 2105, a number of marks 2106, and detailed information 2107. For example, if the user sets a partition sheet between jobs while specifying insertion of a sheet, a shift to the left, two marks, and formation of the three-dimensional mark on the partition sheet setting screen 1801, three-dimensional mark formation page information 2108 is added to the list 2101.

Further, if the user sets a partition sheet between copies while not specifying insertion of a sheet, a shift to the right, one mark, and formation of the three-dimensional mark on the partition sheet setting screen 1801, three-dimensional mark formation page information 2109 is added to the list 2101.

Further, if a copy job is input while setting insertion of a slip sheet as the fourth page and formation of one three-dimensional mark at the top left position on the insertion sheet setting screen 1601, three-dimensional mark formation page information 2110 is added to the list 2101. Further, if a copy job is input while setting formation of two three-dimensional marks at the top left position on a first page, and formation of two three-dimensional marks at the bottom left position on a fifth page on the page selection screen 1201, three-dimensional mark formation page information 2111 and three-dimensional mark formation page information 2112 are added to the list 2101.

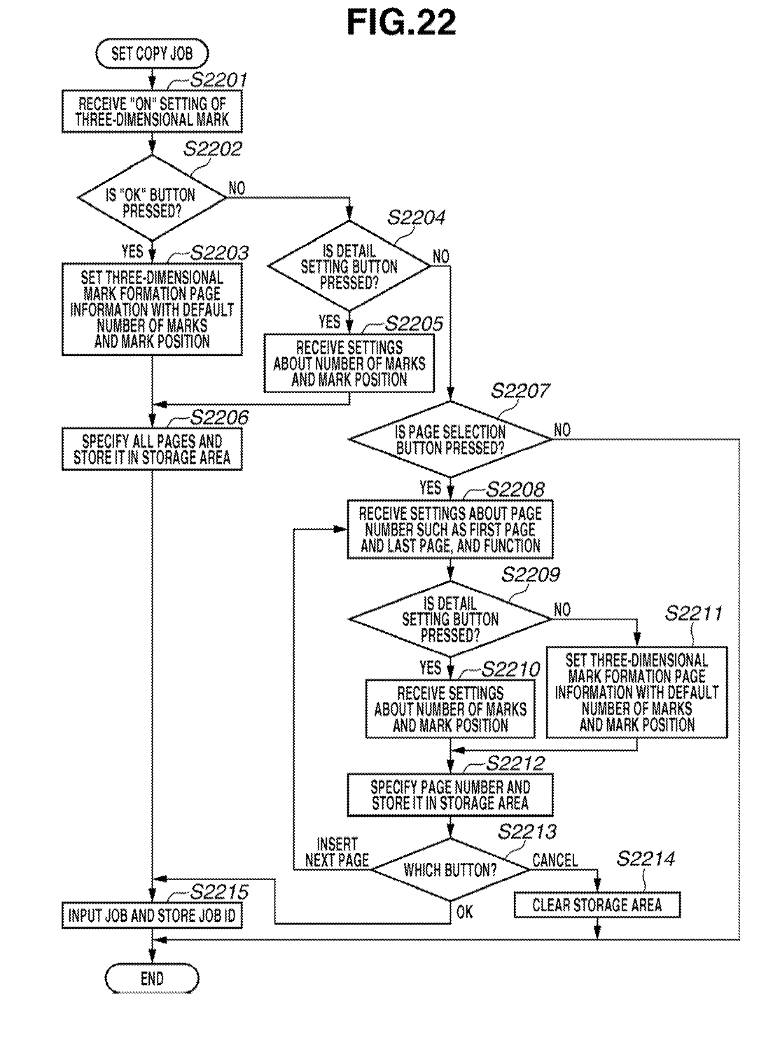

FIG. 22 is a flowchart illustrating a method for controlling the sheet processing apparatus according to the present exemplary embodiment. The processing illustrated in FIG. 22 is an example of processing for setting a copy job to the image processing apparatus 100 illustrated in FIG. 1. The respective steps are realized by the CPU 101 performing the program stored in the ROM 102. In the present exemplary embodiment, the mark formation conditions set from any of the above-described UI screens include a selection of a position where the above-described concave and convex mark is formed, a selection of the number of marks, and a selection of a page where the mark is formed.

Further, the selection of a page where the mark is formed has options of an all page selection for forming the mark on all pages, a page selection for forming the mark on first and last pages, and a page selection for forming the mark on a specific page.

In step S2201, the user sets formation of the three-dimensional mark on the three-dimensional mark setting screen 1101 illustrated in FIG. 11, which is displayed on the operation unit 105, and the CPU 101 receives this setting. In step S2202, the CPU 101 determines whether a key input from the user is the OK key 1106. If the CPU 101 determines that a key input from the user is the OK key 1106 (YES in step S2202), the processing proceeds to step S2203. If the CPU 101 determines that a key input from the user is another input (NO in step S2202), the processing proceeds to step S2204.

In step S2203, the CPU 101 generates three-dimensional mark formation page information with a default mark position and a default number of marks, because the number of marks and the mark position are not set yet. In step S2206, the CPU 101 specifies all pages as a selection of the page number in the three-dimensional mark formation page information. Next, in step S2215, the CPU 101 sets a job ID of a copy job to be input to the three-dimensional mark formation page information, and records it in the three-dimensional mark formation page information list 2101 stored in the DRAM 104.

On the other hand, if the CPU 101 determines in step S2202 that the CPU 101 has received another input than the OK key (NO in step S2202), the processing proceeds to step S2204. In step S2204, the CPU 101 determines whether the user input on the UI screen illustrated in the FIG. 11 is pressing of the detail setting button 1104 for setting details and the CPU 101 has received it. If the CPU 101 determines that the CPU has received pressing of the detail setting button 1104 (YES in step S2204), the processing proceeds to step S2205. If the CPU 101 determines that the CPU 101 has received another key input (NO in step S2204) the processing proceeds to step S2207.

In step S2205, the CPU 101 generates three-dimensional mark formation page information while specifying the number of marks (two marks in the example illustrated in FIG. 14) and the mark position (top left) set by the user on the detail setting screen 1401 illustrated in FIG. 14.

On the other hand, in step S2207, the CPU 101 determines whether the user input is pressing of the page selection button 1105 for selecting a page and the CPU 101 has received it. If the CPU 101 determines that the CPU 101 has received pressing of the page selection button 1105 (YES in step S2007), the processing proceeds to step S2208. If the CPU 101 determines that the CPU 101 has received another key input (NO in step S2007), the CPU ends the present processing.

In step S2208, the CPU 101 generates three-dimensional mark formation page information by receiving the settings about a page number and a function set by the user using the page selection screen 1201 illustrated in FIG. 12 and the insertion sheet setting screen 1601 illustrated in FIG. 16.

Next, in step S2209, the CPU 101 determines whether the CPU 101 has received user's pressing of the detail setting button 1303 for detailed settings on the UI screen illustrated in FIG. 13. If the CPU 101 determines that the CPU 101 has received the user's pressing of the detail setting button 1303 (YES in step S2209), the processing proceeds to step S2210. If the CPU 101 determines that the CPU 101 has received another key input (NO in step S2209), the processing proceeds to step S2211. In step S2210, the CPU 101 receives the number of marks and the mark position set by the user on the detail setting screen 1401 illustrated in FIG. 14 as three-dimensional mark formation page information.

In step S2211, the CPU 101 stores the default mark position and number of marks into the three-dimensional mark formation page information, because the number of marks and the mark position are not set yet. Then, in step S2212, the CPU 101 specifies the set page as a selection of the page number in the three-dimensional mark formation page information, and stores the specified content into the DRAM 104.

In step S2213, the CPU 101 determines whether insertion of a next page is specified by the user. If the CPU 101 determines that insertion of a next page is specified (YES in step S2213), the processing proceeds to step S2208. If the OK button is pressed (OK in step S2213), the processing proceeds to 2215. If the cancel button is pressed (CANCEL in step S2213), the processing proceeds to step S2214.

In step S2214, the CPU 101 clears the three-dimensional mark formation page information list 2101 generated in the DRAM 104, and ends the present processing.

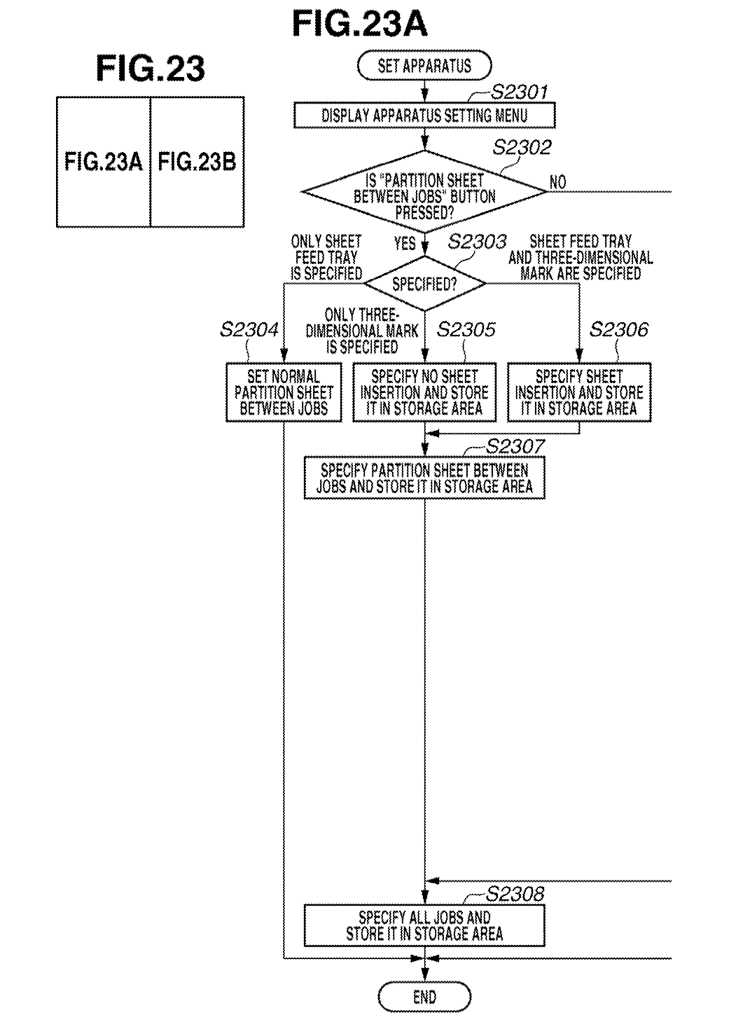

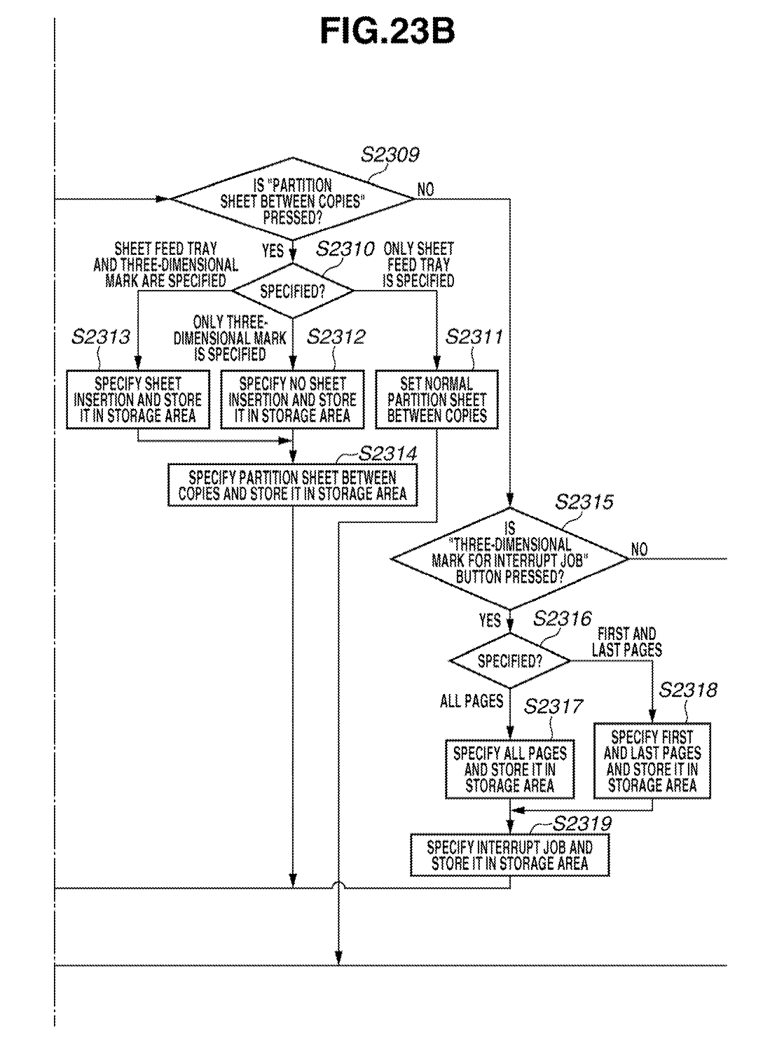

FIG. 23 (divided into FIGS. 23A and 23B) is a flowchart illustrating the method for controlling the sheet processing apparatus according to the present exemplary embodiment. The processing illustrated in FIG. 23 is an example of processing for setting the apparatus according to an operation performed on the UI screen illustrated in FIG. 17. The respective steps are realized by the CPU 101 executing the program stored in the ROM 102. In the present exemplary embodiment, the mark formation conditions set from any of the above-described UI screens include a condition regarding separating sheets according to a specific print mode. Further, the condition regarding separating sheets according to a specific print mode includes options of separating sheets between jobs, separating sheets between copies, and separating an interrupt job.

Further, in an example described below, the option of separating an interrupt job is an option of separating a sheet bundle inserted by an interrupt job.

In step S2301, the CPU 101 displays the setting/registration screen 1701 illustrated in FIG. 17 on the operation unit 105 as a menu screen that allows the user to select a function of setting formation of the three-dimensional mark applied to all jobs. In step S2302, the CPU 101 determines whether a key input by the user is the button 1702 for setting a partition sheet between jobs for partition sheet between jobs on the UI screen illustrated in FIG. 17. If the CPU 101 determines here that a key input by the user is the button 1702 for setting a partition sheet between jobs for partition sheet between jobs (YES in step S2302), the processing proceeds to step S2303. If the CPU 101 determines that a key input by the user is another input (NO in step S2302), the processing proceeds to step S2309.

In step S2303, the CPU 101 determines what is specified by the user on the UI screen illustrated in FIG. 18. If the CPU 101 determines that a user input is only a selection of a sheet feed tray on the UI screen illustrated in FIG. 18 (ONLY SHEET FEED TRAY IS SPECIFIED in step S2303), the processing proceeds to step S2304. If the CPU 101 determines that a user input is only a selection of formation of the three-dimensional mark (ONLY THREE-DIMENSIONAL MARK IS SPECIFIED in step S2303), the processing proceeds to step S2305. If the CPU 101 determines that the user specified both formation of the three-dimensional mark and a selection of a sheet feed tray (SHEET FEED TRAY AND THREE-DIMENSIONAL MARK ARE SPECIFIED in step S2303), the processing proceeds to step S2306.

In step S2304, the CPU 101 determines that the user input is the setting of inserting a partition sheet between jobs without forming the three-dimensional mark, and ends the present processing without updating the three-dimensional mark formation page information list 2101.

In step S2305, the CPU 101 generates three-dimensional mark formation page information while specifying no insertion of a sheet in the details, and then the processing proceeds to step S2307. In step S2306, the CPU 101 generates three-dimensional mark formation page information while specifying insertion of a sheet in the details, and then the processing proceeds to step S2307.

In step S2307, the CPU 101 specifies the partition sheet between jobs in the function of the three-dimensional mark formation page information, and stores it in the DRAM 104. In step S2308, the CPU 101 specifies all jobs in the job ID of the three-dimensional mark formation page information, and stores it in the DRAM 104, and then ends the present processing.

In step S2309, the CPU 101 determines whether the user input is pressing of the button 1703 for setting a partition sheet between copies for partition sheet between copies on the UI screen illustrated in FIG. 17. If the CPU 101 determines here that the user input is pressing of the button 1703 for setting a partition sheet between copies for partition sheet between copies (YES in step S2309), the processing proceeds to step S2310. If the CPU 101 determines that the user input is another key (NO in step S2309), the processing proceeds to step S2315.

In step S2310, the CPU 101 determines what is specified by the user on the UI screen illustrated in FIG. 18. If the CPU 101 determines that the user input is only a selection of a sheet feed tray (ONLY SHEET FEED TRAY IS SPECIFIED in step S2310), the processing proceeds to step S2311. If the CPU 101 determines that the user input is only a selection of formation of the three-dimensional mark (ONLY THREE-DIMENSIONAL MARK IS SPECIFIED in step S2310), the processing proceeds to step S2312. If the CPU 101 determines that the user input is both a selection of formation of the three-dimensional mark and a selection of a sheet feed tray (BOTH SHEET FEED TRAY AND THREE-DIMENSIONAL MARK ARE SPECIFIED in step S2310), the processing proceeds to step S2313.

In step S2311, the CPU 101 determines that the user input is the setting of inserting a partition sheet between copies without forming the three-dimensional mark, and ends the present processing without updating the three-dimensional mark formation page information list 2101.

In step S2312, the CPU 101 generates three-dimensional mark formation page information while specifying no insertion of a sheet in the details. In step S2313, the CPU 101 generates three-dimensional mark formation page information while specifying insertion of a sheet in the details. In step S2314, the CPU 101 specifies the partition sheet between copies in the function of the three-dimensional mark formation page information, and stores it in the DRAM 104.

In step S2315, the CPU 101 determines whether the user input is pressing of the button 1704 for setting formation of the three-dimensional mark for three-dimensional mark for interrupt job on the UI screen illustrated in FIG. 17, and the CPU 101 has received the pressing thereof. If the CPU 101 determines here that the CPU 101 has received pressing of the button 1704 for setting formation of the three-dimensional mark for three-dimensional mark for interrupt job (YES in step S2315), the processing proceeds to step S2316. If the CPU 101 determines that the CPU has received another input (NO in step S2315), the CPU 101 ends the present processing.

In step S2316, the CPU 101 determines whether the user input is pressing of the all-pages specifying button 1902 for specifying all pages on the UI screen illustrated in FIG. 19, and the CPU 101 has received the pressing thereof. If the CPU 101 determines that the user input is pressing of the all-pages specifying button 1902 for specifying all pages and the CPU 101 has received the pressing thereof (YES in step S2316), the processing proceeds to step S2317. On the other hand, if the CPU 101 determines that the CPU 101 has received pressing of the first page and last page specifying button 1903 corresponding to a selection of first and last pages and the CPU 101 has received in (NO in step S2316), the processing proceeds to step S2318.

Then, in step S2317, the CPU 101 generates three-dimensional mark formation page information while specifying all pages. In step S2318, the CPU 101 generates three-dimensional mark formation page information while specifying first and last pages. In step S2319, the CPU 101 specifies the interrupt job in the function of the three-dimensional mark formation page information and stores it in the DRAM 104, and then ends the present processing.

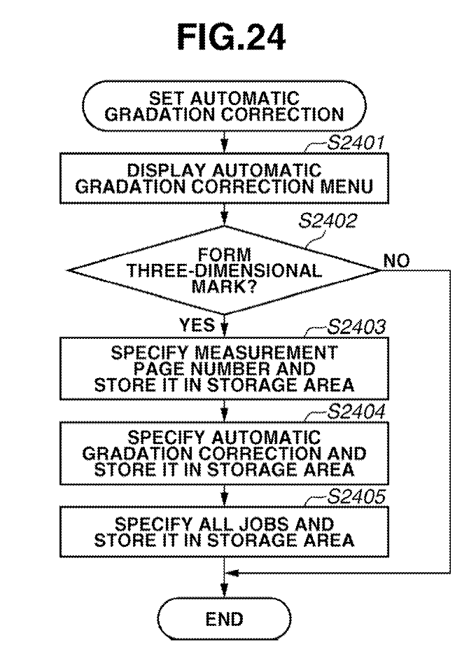

FIG. 24 is a flowchart illustrating a method for controlling the sheet processing apparatus according to the present exemplary embodiment. The processing illustrated in FIG. 23 is an example of processing for setting automatic gradation correction. The respective steps are realized by the CPU 101 executing the program stored in the ROM 102.

In step S2401, the CPU 101 displays the automatic gradation correction setting screen 2001 illustrated in FIG. 20 on the operation unit 105 as an automatic gradation correction menu, and prompts the user to select the number of printouts of a gradation correction pattern. In step S2402, the CPU 101 determines whether the user pressed the button 2003 for specifying whether to form the three-dimensional mark on a last measurement page. If the CPU 101 determines that the user pressed the button 2003 for specifying whether to form the three-dimensional mark on a last measurement page (YES in step S2402), the processing proceeds to step S2403. If the CPU 101 determines that the user input is another key (NO in step S2402), the CPU 101 ends the present processing.

In step S2403, the CPU 101 generates three-dimensional mark formation page information while specifying the input measurement page number. In step S2404, the CPU 101 specifies the automatic gradation correction function in the function of the three-dimensional mark formation page information, and stores it in the DRAM 104. In step S2405, the CPU 101 specifies all jobs in the job ID of the three-dimensional mark formation page information, and stores it in the DRAM 104, and then ends the present processing.

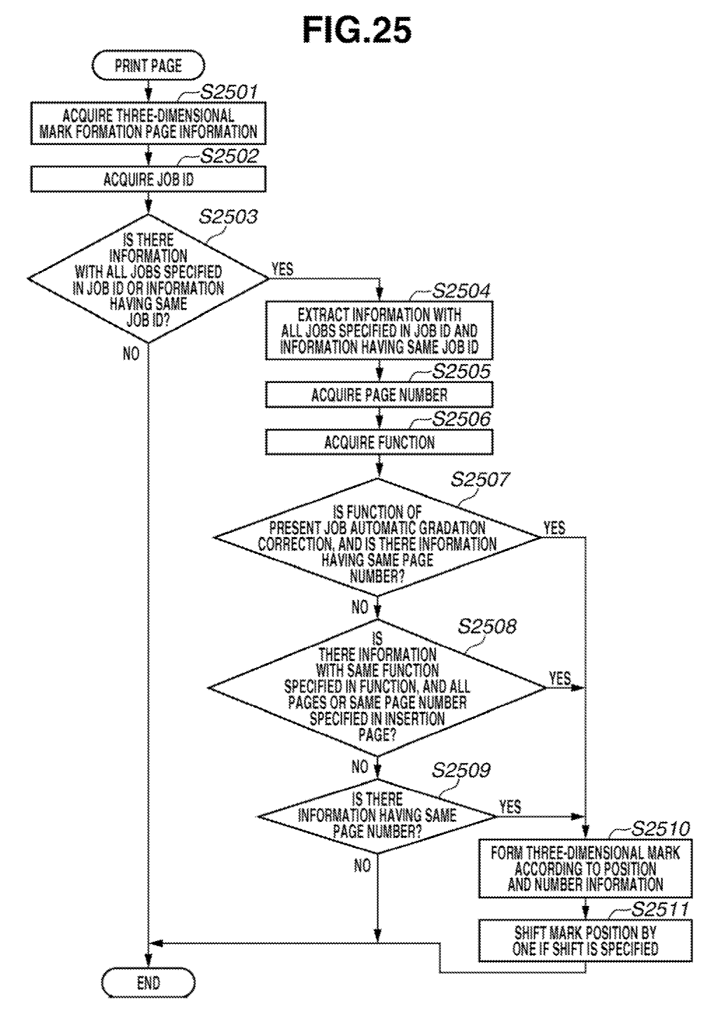

FIG. 25 is a flowchart illustrating a method for controlling the sheet processing apparatus according to the present exemplary embodiment. The processing illustrated in FIG. 23 is an example of processing at the time of printing. The respective steps are realized by the CPU 101 executing the program stored in the ROM 102.

In step S2501, the CPU 101 acquires the three-dimensional mark formation page information list 2101 from the DRAM 104. In step S2502, the CPU 101 acquires a job ID of the present print job from the DRAM 104. In step S2503, the CPU 101 determines whether the three-dimensional mark formation page information list 2101 contains three-dimensional mark formation page information with all jobs specified in the job ID or three-dimensional mark formation page information with the job ID of the present print job specified in the job ID. If there is no such three-dimensional mark formation page information (NO in step S2503), the CPU 101 ends the present processing.

On the other hand, if the CPU 101 determines in step S2503 that the three-dimensional mark formation page information list 2101 contains three-dimensional mark formation page information with all jobs specified in the job ID or three-dimensional mark formation page information with the job ID of the present print job specified in the job ID (YES in step S2503), the processing proceeds to step S2504.

In step S2504, the CPU 101 extracts only three-dimensional mark formation page information with all jobs specified in the job ID and three-dimensional mark formation page information with the job ID of the present print job specified in the job ID from the three-dimensional mark formation page information list 2101 stored in the DRAM 104. In step S2505, the CPU 101 acquires a page number of the present printing operation of the present job from the DRAM 104. In step S2506, the CPU 101 acquires the function of the present job from the DRAM 104.

In step S2507, the CPU 101 determines whether the function of the present job is automatic gradation correction, and the extracted list contains three-dimensional mark formation page information with the same page number specified in the insertion page. If the CPU 101 determines that the function of the present job is automatic gradation correction, and the extracted list contains three-dimensional mark formation page information with the same page number specified in the insertion page (YES in step S2507), the processing proceeds to step S2510.

On the other hand, if the CPU 101 determines in step S2507 that the function of the present job is not automatic gradation correction, or the extracted list does not contain three-dimensional mark formation page information with the same page number specified in the insertion page (NO in step S2507), the processing proceeds to step S2508.

In step S2508, the CPU 101 determines whether the extracted list contains three-dimensional mark formation page information with the same function as the present job specified in the function, and all pages or the same page number specified in the insertion page. If the CPU 101 determines that the extracted list contains three-dimensional mark formation page information with the same function as the present job specified in the function, and all pages or the same page number specified in the insertion page (YES in step S2508), the processing proceeds to step S2510.

On the other hand, if the CPU determines in step S2508 that the extracted list does not contain three-dimensional mark formation page information with the same function as the present job specified in the function, and all pages or the same page number specified in the insertion page (NO in step S2508), the processing proceeds to step S2509.

In step S2509, the CPU 101 determines whether the extracted list contains three-dimensional mark formation page information with the same page number as the present page number specified in the insertion page. If the CPU determines here that the extracted list contains three-dimensional mark formation page information with the same page number as the present page number specified in the insertion page (YES in step S2509), the processing proceeds to step S2510.

On the other hand, if the CPU 101 determines in step S2509 that the extracted list does not contain three-dimensional mark formation page information with the same page number as the present page number specified in the insertion page (NO in step S2509), the CPU ends the present processing.

In step S2510, the CPU 101 instructs the sheet processing unit 201 to form the three-dimensional mark based on the information indicating the specified mark position and number of marks. In step S2511, the CPU 101 shifts internal position information, if a shift is specified as the mark position. Then, the CPU 101 ends the present processing.

As a result, when using the sheet insertion function, it is possible to more easily specify where an inserted sheet exists by viewing or feeling it from stacked outputs than use of a sheet of a different color or type as an inserted sheet or printing of a special mark. Further, when using the interrupt copy function, it is possible to easily specify an output sheet of the interrupt job inserted among a plurality of outputs from stacked outputs.

Further, when performing automatic gradation correction, it is also possible to easily specify a last sheet usable for this correction from stacked outputs. Further, it is possible to reduce the user cost by preventing unnecessary use of extra sheets and refraining from consuming consumable supplies such as toner and staples.

The present invention is not limited to the above-described exemplary embodiments, and can be modified in various manners (including variable combinations of respective exemplary embodiments) according to the spirit of the present invention, and such various modifications are also within the scope of the present invention.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-262450 filed Nov. 30, 2012, which is hereby incorporated by reference herein in its entirety.

What is claimed is:

1. A sheet processing apparatus comprising:
a binding unit configured to perform a binding process for binding a plurality of sheets without use of a staple;
a setting unit configured to set a sheet on which a concave and convex mark is to be formed by the binding unit; and
a control unit configured to control the binding unit so as to form the concave and convex mark on the sheet set by the setting unit.

2. The sheet processing apparatus according to claim 1, further comprising a specifying unit configured to specify a position of the concave and convex mark or the number of concave and convex marks.

3. The sheet processing apparatus according to claim 1, wherein the setting unit can specify all sheets or first and last sheets as the sheet on which the concave and convex mark is to be formed.

4. A control method for controlling a sheet processing apparatus, the control method comprising:
performing a binding process for binding a plurality of sheets without use of a staple by a binding unit;
setting a sheet on which a concave and convex mark is to be formed by the binding unit; and
controlling the binding unit so as to form the concave and convex mark on the set sheet.

5. A computer readable storage medium for storing a computer program for controlling a sheet processing apparatus, the computer program comprising:
a code to perform a binding process for binding a plurality of sheets without use of a staple by a binding unit;
a code to set a sheet on which a concave and convex mark is to be formed by the binding unit; and
a code to control the binding unit so as to form the concave and convex mark on the set sheet.
